(19) United States
(12) Patent Application Publication
(10) Pub. No.: US 2025/0153615 A1
(43) Pub. Date: May 15, 2025

(54) VEHICLE SEAT ASSEMBLY COMPRISING TWO VEHICLE SEATS WHICH CAN BE MUTUALLY SPACED IN A TRANSVERSAL DIRECTION

(71) Applicant: BROSE FAHRZEUGTEILE SE & CO. KOMMANDITGESELLSCHAFT, COBURG, Coburg (DE)

(72) Inventor: Jörg GROPP, Böhlen (DE)

(21) Appl. No.: 18/839,679

(22) PCT Filed: Feb. 20, 2023
(86) PCT No.: PCT/EP2023/054135

§ 371 Date: Aug. 19, 2024

(30) Foreign Application Priority Data
Feb. 23, 2022 (DE) 10 2022 104 330.4

(51) Int. Cl. B60N 2/06

(52) U.S. Cl. CPC B60N 2/062

(57) ABSTRACT

It is provided a vehicle seat assembly comprising two vehicle seats which are arranged adjacently to one another along a transverse axis, the spacing of which relative to one another along the transverse axis can be adjusted. In order to adjust the spacing between the vehicle seats, a drive assembly is provided, having a motor, at least one gearing mechanism which is coupled to the motor, and two adjustment devices which are coupled to the gearing mechanism, wherein a first adjustment device for adjusting one vehicle seat along the transverse axis and a second adjustment device for adjusting the other vehicle seat along the transverse axis are provided, and wherein a drive force generated by the motor can be transferred to the two adjustment devices via the gearing mechanism.

### TECHNICAL FIELD

The proposed solution relates to a vehicle seat assembly comprising two vehicle seats which are arranged adjacently to one another along a transverse axis, the spacing of which relative to one another along the transverse axis can be adjusted.

It is already known from the field of vehicles to be able to adjust vehicle seats located side-by-side, in a variable manner in the longitudinal direction. Optionally, such seats of the first, second or third seat row are adjustable in portions even along a transverse axis (and thus optionally in addition to an adjustment possibility along a longitudinal axis). In practice, however, such adjustment possibilities are encountered still comparatively rarely. This applies in particular for a possibility known from DE 10 2006 020 671 A1 for adjusting a seat width.

However, concepts are absolutely already known for being able to adjust entire vehicle seats, for example for self-driving vehicles, at a transverse distance from one another, in order to be able to offer greater comfort for vehicle occupants. However, the constructions provided hitherto for corresponding adjustability of the vehicle seats are comparatively complex and heavy.

### BACKGROUND AND SUMMARY

The problem which the proposed solution addresses is that of providing a remedy in this respect.

For this, the proposed solution proposes a vehicle seat assembly in which, in order to adjust the (transverse) spacing between two vehicle seats along a transverse axis, a drive assembly is provided, having a motor, at least one gearing mechanism coupled to the motor, and two adjustment devices coupled to the gearing mechanism. A first adjustment device of the two adjustment devices is provided for adjusting one of the two vehicle seats along the transverse axis, and a second adjustment device is provided for adjusting the other vehicle seat along the transverse axis, wherein a drive force generated by the motor can be transferred via the gearing mechanism both to the first adjustment device and to the second adjustment device.

Consequently, using two gearing mechanisms coupled to different adjustment devices makes it possible, here, for adjustment of both vehicle seats along the transverse axis to be achieved using exactly one (single) motor of the drive assembly. This in particular includes the situation where a drive force generated by the motor can be implemented by the drive assembly for synchronously adjusting the two vehicle seats along the transverse axis. Thus, the two vehicle seats can be adjusted towards one another or away from one another along the transverse axis using exactly one motor. It is therefore not necessary to use one motor per adjustment device, which saves weight and reduces complexity for the drive assembly, which would otherwise have to ensure synchronization of the motors for example.

In a variant, at least one of the adjustment devices comprises a spindle drive for adjusting a vehicle seat along the transverse axis. In a development, all the adjustment devices of the drive assembly are in each case equipped with a spindle drive. In this case, the corresponding configuration of the adjustment devices, to be as similar as possible or even identical, for each of the vehicle seats allows as large as possible a number of common parts to be used, which in turn leads to cost advantages.

In this case, a spindle drive can for example comprise a rotatable drive spindle, which is coupled to the gearing mechanism. Therefore, in the case of a drive force generated by the motor, a rotation of the drive spindle is brought about via the gearing mechanism. In particular it can be provided, in this connection, that a first, anticlockwise-rotating drive spindle is provided for the first adjustment device, and a second, clockwise-rotating drive spindle is provided for the second adjustment device.

In a variant, at least one of the adjustment devices comprises a rail arrangement having a first rail element that is to be fixed to a floor of a vehicle, and a second rail element that is displaceably mounted on the first rail element and is connected to the respective vehicle seat. The vehicle seat is then adjustable along the transverse axis, by means of the motor, via the second displaceably mounted rail element. For this purpose, for example a seat base frame of the vehicle seat is fixed to the second rail element. In a development, all the adjustment devices are in each case equipped with a rail arrangement having first and second rail elements.

Alternatively or in addition, a displaceably mounted second rail element can be coupled to a rotatable drive spindle of the spindle drive of the associated adjustment device, such that when the drive spindle is rotated the second rail element is adjustable on the first rail element, along the transverse axis.

For example, the motor is coupled to the gearing mechanism via a drive shaft, in particular a flexible shaft.

In a variant, two adjustment devices are provided per vehicle seat. Therefore, with respect to a longitudinal axis pointing from a rear side to a front side of the vehicle seat, a front adjustment device and a rear adjustment device are provided for a vehicle seat. Thus, a corresponding vehicle seat is then mounted so as to be adjustable along the transverse axis, via the two adjustment devices associated therewith, in a front part and a rear part in each case. In this case, the use of two adjustment devices per vehicle seat promotes secure mounting of the vehicle seat on the vehicle floor, and furthermore increases the stability, in particular during the adjustment along the transverse axis.

In order, in a variant of this kind, to still keep the number of components necessary for adjustment of the two vehicle seats along the transverse axis as small as possible, and to also keep the complexity of the drive system provided with the drive assembly as low as possible, in a variant of this kind, too, it is possible for only precisely one individual motor of the drive assembly to be provided for transferring adjustment forces to the overall at least four adjustment devices for the two vehicle seats. For this purpose, the drive assembly then comprises at least one further gearing mechanism, which is coupled to the two further (third and fourth) adjustment devices. The motor of the drive assembly is thus coupled to two gearing mechanisms, which are in each case coupled to two adjustment devices assigned to different vehicle seats.

Thus, a drive force generated by the motor can be divided via two gearing mechanisms over the four adjustment devices for the vehicle seats, in order to adjust the two vehicle seats along the transverse axis. The adjustment of a spacing between the two vehicle seats along the transverse axis thus takes place in an externally powered manner by precisely one motor, which in each case drives two adjustment devices for a vehicle seat, in order to adjust the vehicle seats towards one another or away from one another, along the transverse axis.

In this case, the motor can for example be connected via a first drive shaft to a first gearing mechanism, and via a second drive shaft to a second gearing mechanism. In this case, said drive shafts can in particular each extend perpendicularly to the transverse axis. For example, the drive motor is arranged, along a longitudinal axis extending perpendicularly to the transverse axis, between the two drive shafts, on the respective end of which one or the other gearing mechanism is provided.

For example, the motor comprises two flexible shaft outputs, such that in each case one drive shaft, configured as a flexible shaft, is connected to one of the two gearing mechanisms.

For providing a higher adjusting force via the drive assembly, this can, in a variant, comprise an additional motor that is coupled to the motor. The additional motor is then for example connected in series and synchronized with the one motor, such that the two motors in combination can provided a higher drive force. In particular, the motor and the additional motor can be configured identically in this case. Coupling of the additional motor to the one motor can take place via a coupling shaft, in particular via a flexible shaft.

In a variant, the one motor and the additional motor are arranged one behind the other along a longitudinal axis, e.g. in particular such that the shafts driven thereby extend coaxially to one another.

The proposed solution furthermore also relates to a vehicle having at least one variant of a proposed vehicle seat assembly. In this case, a transverse axis along which the at least two vehicle seats of the vehicle seat assembly can be spaced apart relative to one another can then coincide with a vehicle transverse axis. In this way, not only can a transverse spacing between the two vehicle seats inside the vehicle interior be adjustable by means of the vehicle seat assembly, but rather the spacing of said vehicle seats from a respective longitudinal side of the vehicle can also be adjustable.

### BRIEF DESCRIPTION OF THE DRAWINGS

The accompanying drawing illustrates, by way of example, possible variants of the proposed solution, in which:

FIG. 1 is a schematic plan view of a variant of the proposed solution, having a drive assembly comprising two gearing mechanisms and four adjustment devices.

### DETAILED DESCRIPTION

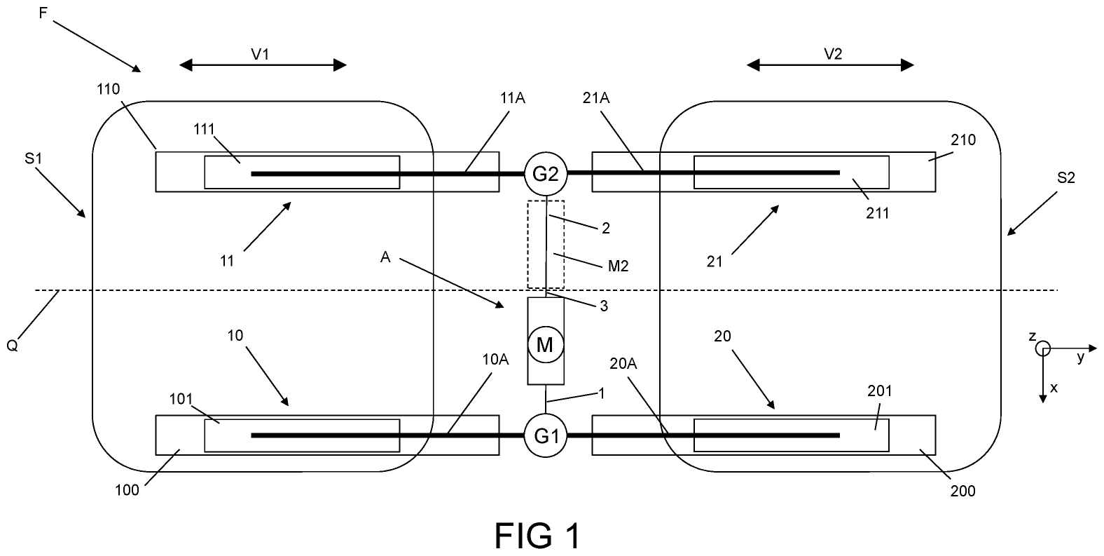

In the variant of a vehicle seat assembly F of FIG. 1, two vehicle seats S1 and S2 (shown schematically here) are arranged side-by-side along a transverse axis Q. The transverse axis Q can, for example in the case of an arrangement of the vehicle seat assembly F in an interior of the vehicle, correspond to a vehicle transverse axis. In this case, the two vehicle seats S1 and S2 are adjustable along the transverse axis Q, along adjustment directions V1 and V2. In this way, in particular a spacing between the two vehicle seats S1 and S2 along the transverse axis Q can be adjusted.

For the synchronous adjustment of the vehicle seats S1 and S2 along the transverse axis Q, a drive assembly A is provided which comprises exactly one individual (drive) motor M, for example in the form of an electric motor. Said motor M of the drive assembly A is coupled by two drive shafts, configured here as flexible shafts 1 and 2, to two gearing mechanisms G1 and G2, which are in each case associated with two adjustment devices 10, 20 or 11, 21. Thus, both an adjustment device 10 or 11 for one vehicle seat S1, and an adjustment device 20 or 21 for the other vehicle seat S2, are connected to each gearing mechanism G1 or G2. Thus, in terms of gearing mechanism, in each case two adjustment devices 10/20 or 11/21 are provided for adjusting the two vehicle seats S1 or S2 along the transverse axis Q.

Furthermore, two adjustment devices 10, 11 or 20, 21 are provided for each vehicle seat S1 or S2. For example, one vehicle seat S1 is assigned front and rear adjustment devices 10 and 11, based on a seat longitudinal axis extending perpendicularly to the transverse axis Q (in the present case along the spatial direction x), while the other vehicle seat S2 is assigned two front and rear adjustment devices 20 and 21.

The motor M of the drive assembly A is arranged between the two gearing mechanisms G1 and G2, based on the seat longitudinal axes, and thus in an intermediate space between a pair of adjustment devices 10/20 and 11/21, respectively, associated with one gearing mechanism G1 or G2, respectively. Accordingly, the flexible shafts 1 and 2 also extend substantially perpendicularly to the transverse axis Q, from the motor M to the gearing mechanism G1 or G2.

In the present case, each of the adjustment devices 10, 11, 20, 21 is configured having a spindle drive. In this case, each spindle drive comprises a rotatably mounted drive spindle 10A, 11A, 20A or 21A. While the drive spindle 10A, 20A of a front adjustment device 10 or 20 for a vehicle seat S1 and S2 is in each case coupled to the (first) gearing mechanism G1, a drive spindle 11A or 21A of a rear adjustment device 11 or 21 of a vehicle seat S1 and S2 is coupled to the other (second) gearing mechanism G2.

Part of each adjustment device 10, 11, 20, 21 is furthermore a rail arrangement having two rail elements 100/101, 110/111, 200/201 or 210/211 that are mounted so as to be longitudinally adjustable relative to one another. In this case, a first rail element 100, 110, 200 or 210 is configured in each case as a lower rail, which is to be fixed on a vehicle floor and in the installed state of the vehicle seat assembly F is thus fixed to the vehicle body. A second rail element 101, 111, 201 or 211 is configured in each case as an upper rail and is mounted on the respective first rail element 100, 110, 200 or 210 so as to be displaceable along the transverse axis Q. Each second rail element 101, 111, 201 or 211 is coupled to a respectively associated drive spindle 10A, 11A, 20A or 21A, such that when the respective drive spindle 10A, 11A, 20A, 21A is rotated as a result of a drive force applied by the motor, the second rail element 101, 111, 201 and 211 is adjusted on the respective first rail element 100, 110; 200, 210, along the transverse axis Q.

In the variant shown, the drive spindle 10A, 11A or 20A, 21A associated with a vehicle seat S1 or S2 is in each case configured having an identical thread pitch. The drive spindles for the different vehicle seats S1 and S2 are furthermore configured having mutually opposing thread pitches. Thus, for example a pair of drive spindles 10A, 11A for one vehicle seat S1 is configured having right-handed external threads, and thus to be clockwise-rotating, while a pair of drive spindles 20A, 21A for the other vehicle seat S2 is configured having left-handed external threads, and thus so as to be anticlockwise-rotating. Each gearing mechanism G1, G2 is thus configured and provided for coupling both to a clockwise-rotating and also to an anticlockwise-rotating drive spindle 10A, 20A or 11A, 21A.

Thus, in the case of actuation of the motor M, and a drive force thus applied by the motor M, the two flexible shafts 1 and 2 are rotated, and the drive force is divided, by the gearing mechanism G1 and G2, over a total of four adjustment devices 10, 11, 20 and 21. The rotation of the drive spindles 10A, 11A, 20A and 21A about their respective spindle longitudinal axis thus leads, via the different right-hand threaded and left-hand threaded drive spindles 10A, 11A and 20A, 21A, to synchronous adjustments of the second rail elements 101, 111 and 201, 211 in mutually opposing adjustment directions V1 and V2, such that the vehicle seats S1 or S2 connected to the second rail elements 101, 111, 201 and 211—depending on the direction of rotation of the torque applied by the motor M—are adjusted either towards one another or away from one another, along the transverse axis Q.

The variant of the drive assembly A of FIG. 1 thus allows for synchronous adjustment of the vehicle seats S1 and S2 long the transverse axis Q with a comparatively low number of components and a comparatively uncomplicated drive system. Instead of the variant shown, it can also be provided for each gearing mechanism G1, G2 to be assigned exactly one motor of the drive assembly A (in the case, then, of at least two drive motors). A motor M of the drive assembly A can furthermore be configured as a direct current motor, in particular as a brushless direct current motor, which typically allows for more precise speed control and/or a higher adjustment speed.

Alternatively, or in addition, in a variant the motor M can also be arranged in parallel with a pair of different vehicle seats S1, S2 and drive spindles 10A, 20A or 11A, 21A extending coaxially to one another. Then, here, a shaft axis of a drive shaft that is driven by the motor M and coupled to the respective gearing mechanism G1 or G2, consequently extends in parallel with a spindle axis of the drive spindles 10A, 20A or 11A, 21A.

For providing a higher adjusting force via the drive assembly A, this can, in a variant, comprise an additional motor M2 (shown in dashed lines in FIG. 1) that is coupled to the motor M. In this case, the additional motor M2 can be connected in series and synchronized with the one motor M, such that the two motors M and M2 in combination can provided a higher drive force. In particular, the motor M and the additional motor M2 can be provided by identical electric motors.

In the variant shown in FIG. 1, coupling of the additional motor M2 to the motor M takes place via a coupling shaft in the form of a flexible shaft 3. Said flexible shaft 3 can extend along a longitudinal axis that is perpendicular to the transverse axis Q, along which the additional motor M2 and the motor M are arranged one behind the other.

### LIST OF REFERENCE SIGNS

1, 2 Drive shaft
10, 11 Adjustment device
100, 110 Lower rail
101, 111 Upper rail
10A, 11A Drive spindle
20, 21 Adjustment device
200, 210 Lower rail
201, 211 Upper rail
20A, 21A Drive spindle
3 Flexible shaft
A Drive assembly
F Vehicle seat assembly
G1, G2 Gearing mechanism
M Motor
M2 Additional motor
Q Transverse axis
S1, S2 Vehicle seat
V1, V2 Adjustment direction

1. A vehicle seat assembly, comprising two vehicle seats which are arranged adjacently to one another along a transverse axis, the spacing of which relative to one another along the transverse axis can be adjusted,
wherein in order to adjust the spacing between the vehicle seats, a drive assembly is provided, which comprises a motor, at least one gearing mechanism which is coupled to the motor, and two adjustment devices which are coupled to the gearing mechanism, wherein a first adjustment device for adjusting one vehicle seat along the transverse axis and a second adjustment device for adjusting the other vehicle seat along the transverse axis are provided, and wherein a drive force generated by the motor can be transferred to both the first adjustment device and the second adjustment device via the gearing mechanism.

2. The vehicle seat assembly according to claim 1, wherein a drive force generated by the motor can be implemented via the drive assembly for synchronously adjusting the two vehicle seats towards or away from one another along the transverse axis.

3. The vehicle seat assembly according to claim 1, wherein at least one of the adjustment devices comprises a spindle drive.

4. The vehicle seat assembly to claim 2, wherein the spindle drive comprises a rotatable drive spindle that is coupled to the gearing mechanism.

5. The vehicle seat assembly according to claim 1, wherein at least one of the adjustment devices comprises a rail arrangement having a first rail element that is to be fixed to a floor of a vehicle, and a second rail element that is displaceably mounted on the first rail element and is connected to the respective vehicle seat.

6. The vehicle seat assembly according to claim 4, wherein at least one of the adjustment devices comprises a rail arrangement having a first rail element that is to be fixed to a floor of a vehicle, and a second rail element that is displaceably mounted on the first rail element and is connected to the respective vehicle seat, wherein the displaceably mounted second rail element is coupled to the rotatable drive spindle of the associated adjustment device, such that when the drive spindle is rotated the second rail element is adjustable along the transverse axis on the first rail element.

7. The vehicle seat assembly according to claim 1, wherein the motor is coupled to the gearing mechanism via a flexible shaft.

8. The vehicle seat assembly according to claim 1, wherein the drive assembly comprises a further gearing mechanism that is coupled to the motor, and two further adjustment devices that are coupled to the further gearing mechanism, of which a third adjustment device is also provided for adjusting one vehicle seat along the transverse axis, and a fourth adjustment device is also provided for adjusting the other vehicle seat along the transverse axis.

9. The vehicle seat assembly according to claim 8, wherein a drive force generated by the one motor is divided via the two gearing mechanisms among the four adjustment devices of the two vehicle seats, in order to adjust the two vehicle seats along the transverse axis.

10. The vehicle seat assembly according to claim 7, wherein the drive assembly comprises a further gearing mechanism that is coupled to the motor, and two further adjustment devices that are coupled to the further gearing mechanism, of which a third adjustment device is also provided for adjusting one vehicle seat along the transverse axis, and a fourth adjustment device is also provided for adjusting the other vehicle seat along the transverse axis, wherein the motor comprises two flexible shaft outputs and one flexible shaft in each case is connected to one of the two gearing mechanisms.

11. The vehicle seat assembly according to claim 1, wherein the one drive assembly comprises an additional motor that is coupled to the motor.

12. The vehicle seat assembly according to claim 11, wherein the additional motor is coupled to the motor via a flexible shaft and is connected in series with the motor.

13. A vehicle comprising at least one vehicle seat assembly according to claim 1.
